(19) United States
(12) Patent Application Publication
(10) Pub. No.: US 2019/0202368 A1
(43) Pub. Date: Jul. 4, 2019

(54) STROLLER RACK FOR VEHICLE

(71) Applicant: Nickelle Partyka, Burlington, CT (US)

(72) Inventor: Nickelle Partyka, Burlington, CT (US)

(21) Appl. No.: 16/236,586

(22) Filed: Dec. 30, 2018

Related U.S. Application Data
(60) Provisional application No. 62/612,668, filed on Jan. 1, 2018.

(51) Int. Cl. B60R 9/06; B60D 1/52

(52) U.S. Cl. CPC B60R 9/06; B60D 2001/005; B60D 1/52

(57) ABSTRACT

A stroller rack for a vehicle is disclosed. The stroller rack includes an extendable leg having a first member configured to attach with the vehicle and a second member configured to move relative to the first member along a first axis. The stroller rack includes an extendable arm detachably coupled to the second member of the extendable leg, and including one or more locking bars configured to move relative to the second member along a second axis and attach with a handle of one or more strollers. The stroller rack further includes a base detachably coupled to the first member of the extendable leg, and including one or more holding members configured to couple with one or more wheels of the one or more strollers.

### CROSS-REFERENCE TO RELATED APPLICATIONS

This application claims benefit of Provisional Application No. 62/612,668 filed on Jan. 1, 2018 which is incorporated herein in its entirety.

### FIELD OF THE DISCLOSURE

The invention relates to a stroller rack for a vehicle, and more particularly relates to the stroller rack for mounting a stroller to a rear end of the vehicle.

### BACKGROUND OF THE DISCLOSURE

Stroller are used to carry children and infants. A variety of strollers are manufactured and designed for children of similar age or with a small age gap. Generally, transportation of strollers by an automobile is a tedious task due to various specifications of the stroller such as size, weight, folding constraints, and shape. Further, the strollers may consume a lot of space within a vehicle. Hence, mounting racks similar to bike mounting racks have been developed to carry a stroller on a vehicle. Typically, the strollers are mounted to the rear end of the vehicle using the mounting racks. However, the existing mounting rack are specifically designed to support a particular design or make of a stroller. Also, the existing mounting racks are designed for mounting with only a hitch mount of a vehicle. Furthermore, prior art mounting racks are not designed to carry more than one stroller at a time. Hence, there remains a need for a rack that assists in mounting of strollers with various designs and configurations to any type of the vehicle. And, in addition, there is a need for a rack that conveniently carries more than one stroller, regardless of its design or make, simultaneously.

### SUMMARY OF THE DISCLOSURE

In accordance with the present disclosure, a stroller rack is configured for attaching to a vehicle which allows for the transport of one or more strollers of varying styles, sizes, weights, folding constraints, etc. In one aspect of the present disclosure, a stroller rack for mounting to a vehicle and carrying a one or more strollers of varying styles is provided. The stroller rack includes an extendable leg having a first member configured to attach with the vehicle and a second member configured to move relative to the first member along a first axis. The stroller rack includes an extendable arm detachably coupled to the second member of the extendable leg. The extendable arm includes one or more locking bars configured to move relative to the second member along a second axis. The second axis is generally perpendicular to the first axis. The one or more locking bars are further configured to attach with a handle of one or more strollers. The stroller rack further includes a base detachably coupled to the first member of the extendable leg. The base includes one or more holding members configured to couple with one or more wheels of the one or more strollers.

Other features and aspects of the disclosure will be apparent from the following description and the accompanying drawings.

### BRIEF DESCRIPTION OF THE DRAWINGS

While the specification concludes with claims particularly pointing out and distinctly claiming particular embodiments of the present disclosure, various embodiments of the present disclosure can be more readily understood and appreciated from the following descriptions of various embodiments of the present disclosure when read in conjunction with the accompanying drawings, in which:

FIG. 1 is a perspective view showing an exemplary stroller attached to a stroller rack mounted at a rear end of a vehicle, according to an embodiment of the present disclosure;

FIG. 2 is an exploded view of the stroller rack of FIG. 1 coupled to the rear end of a vehicle, according to one embodiment of the present disclosure;

FIG. 3 is a partial exploded view of a stroller rack for coupling with a hitch mount of a vehicle, according to another embodiment of the present disclosure;

FIG. 4 is a partial exploded view of a stroller rack for attaching with a trunk portion of a vehicle, according to yet another embodiment of the present disclosure; and

FIG. 5 is a perspective view of a stroller rack for carrying multiple strollers on a vehicle, according to yet another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

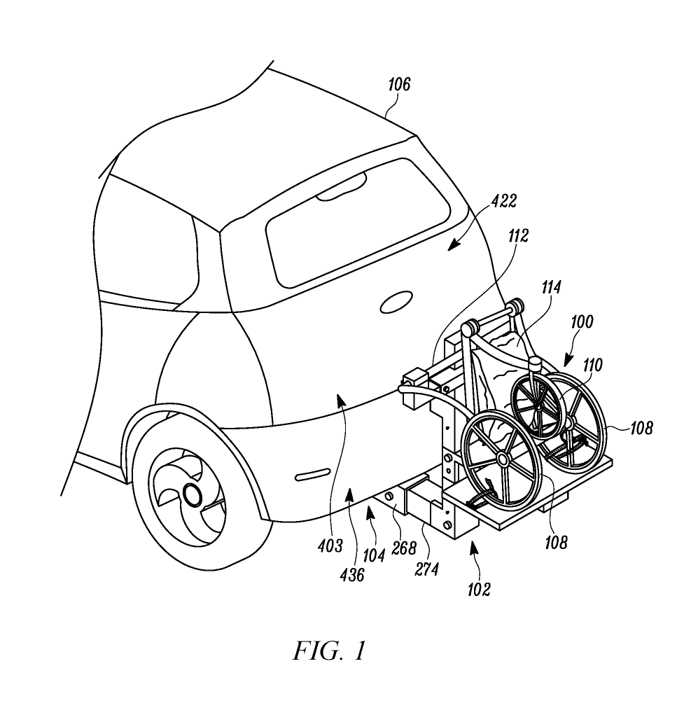

FIG. 1 illustrates a perspective view showing an exemplary stroller 100 attached to a stroller rack 102 mounted at an end (for example a rear end 104) of a vehicle 106, according to an embodiment of the present disclosure. In the illustrated embodiment, the vehicle 106 is a hatchback car. Although, the vehicle 106 is depicted as a hatchback car, it may be understood that the vehicle 106 may alternatively be a sport utility vehicle (SUV), a sedan car, a minivan, a compact car, a pickup truck, or any other vehicle that facilitates mounting of the stroller 100 to the stroller rack 102 at the rear end 104 of the vehicle 106.

The stroller 100 may be a hand-pushed vehicle (e.g., pram) to carry children and infants. In particular, the stroller 100 may be a wheeled device used for transporting children of various ages and sizes. The stroller 100 includes a pair of rear wheels 108, a front wheel 110, a handle 112, and a seat 114. The seat 114 may be provided to accommodate a child within the stroller 100. In an example, the stroller 100 may be manufactured using aluminum or steel framing, cloth for the seat 114, and metal, plastic, or other suitable material for the handle 112, the pair of rear wheels 108, and the front wheel 110. In an example, a variety of strollers may be manufactured and designed for children of similar age or with a small age gap. The stroller 100 may be anyone of, but not limited to, a standard stroller, a jogging stroller, a double stroller, a lightweight stroller, or a side by side double stroller. The standard stroller may be designed to allow children to recline and lie on their back, and the jogging stroller may facilitate a smooth ride (by type of wheel configured thereon, for example) for children on any surface that parents choose for jogging. Further, a double stroller may be manufactured and designed to accommodate two children, where one child sits in a front seat, and the other child sits in a rearward seat, enabling easy maneuvering in crowded places. The lightweight stroller may be best suited for toddlers or children who are one year old and the side by side double stroller may be designed in such a way that two children are seated side by side, making the side by side double stroller easier to maneuver in crowded places.

In the illustrated embodiment, the stroller 100 is a standard stroller capable of accommodating one child. The stroller 100 is attached to the vehicle 106 with the help of the stroller rack 102 mounted at the rear end 104 of the vehicle 106, as shown in FIG. 1. In the illustrated embodiment, although, the stroller rack 102 is used to carry the stroller 100, it may be understood that alternate vehicles for transportation of children, such as prams, infant car seats, portable bassinets, bicycle carriers, backpacks or slings, may also be carried by the stroller rack 102.

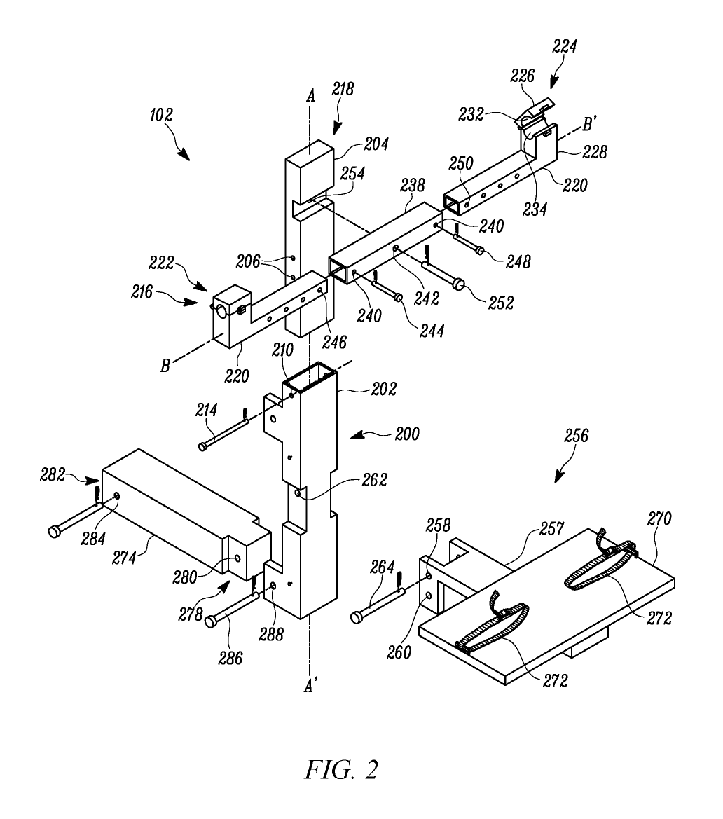

As described above, the stroller 100 is attached to the stroller rack 102 mounted at the rear end 104 of the vehicle 106. Further, the stroller rack 102 is configured to couple with the pair of rear wheels 108 and the handle 112 of the stroller 100. The constructional and functional features of various embodiments of the stroller rack 102 and various methods of coupling between the stroller rack 102 and the rear end 104 of the vehicle 106 are explained in detail in FIGS. 2, 3, 4, and 5.

FIG. 2 illustrates an exploded view of the stroller rack 102 of FIG. 1 coupled to the rear end 104 of the vehicle 106, according to an embodiment of the present disclosure. The stroller rack 102 includes an extendable leg 200 including a first member 202 configured to attach with the vehicle 106. The extendable leg 200 further includes a second member 204 configured to move relative to the first member 202 along a first axis A-A′. In the illustrated embodiment, the extendable leg 200 has a rectangular cross-section. In other examples, the extendable leg 200 may have a circular cross-section, a square cross section, a polygon cross section, or other shape that facilitates relative movement between members 202 and 204. Further, the second member 204 has a telescopic movement with respect to the first member 202. More particularly, the second member 204 is configured to slide into the first member 202 and slide out of the first member 202. The second member 204 defines multiple through holes 206 and the first member 202 defines a first through hole 210 corresponding to each of the multiple through holes 206 of the second member 204. A pin 214 is used to couple the first member 202 with the second member 204 when one of the multiple through holes 206 of the second member 204 is aligned with the first through hole 210 of the first member 202. The pin 214 may be used to couple the second member 204 with the first member 202 in a desired position based on a height of the stroller 100. Thus, a height of the extendible leg 200 may be adjusted to carry strollers having different sizes, e.g., various heights.

The stroller rack 102 further incudes an extendable arm 216 detachably coupled to the second member 204 of the extendable leg 200. More particularly, the extendable arm 216 is coupled proximal to a top portion 218 of the extendable leg 200. In the illustrated embodiment, the extendable arm 216 is having a rectangular cross-section. In other examples, the extendable arm 216 may have a circular cross-section, a square cross section, a polygon cross section, or other shape that facilitates relative movement between members 218 and 238. The extendable arm 216 includes a pair of locking bars 220. Each locking bar 220 is configured to move relative to the second member 204 along a second axis B-B′ that is perpendicular to the first axis A-A′. Further, each locking bar 220 is configured to attach with the handle 112 of the stroller 100. In the illustrated embodiment, one locking bar 220 is located at a first end 222 and another locking bar 220 is located at a second end 224 of the extendable arm 216. Each locking bar 220 includes a pivot member 226 and a vertical projection 228. The pivot member 226 is pivotally coupled at one edge of the vertical projection 228 and, hence rotatable about the edge of the vertical projection 228. The pivot member 226 is movable between an open position (shown at the second end 224) and a closed position (shown at the first end 222). The pivot member 226 is configured to secure the handle 112 of the stroller 100, at the closed position thereof. In the illustrated embodiment, the pivot member 226 defines a first groove 232, and the vertical projection 228 defines a second groove 234. The first groove 232 and the second groove 234 define a cavity to receive and secure the handle 112 of the stroller 100. Although, the cavity has a circular cross section, it may be understood that the cavity may have a square cross section, a rectangular cross section, a polygon cross section, or other shape that facilitates securing the handle 112. In an alternate embodiment, the locking bar 220 of the extendable arm 216 may include a clamping arrangement (not shown) to couple with the handle 112 of the stroller 100. In yet another embodiment, the locking bar 220 may include a belt or a strap to couple with the handle 112 of the stroller 100.

In another embodiment, the locking bar 220 may include an elongated bar having a cylindrical extension. The locking bar 220 may further include a vertical extension detachably coupled to the elongated bar. More particularly, the vertical extension may include a blind hole at a bottom end thereof to receive the cylindrical extension of the elongated bar. As such, the vertical extension may be rotated 360 degrees about the second axis B-B′. The vertical extension may further include a threaded hole to receive a bolt. The bolt may be used to retain the vertical extension at a desired position. The locking bar 220 may further include a locking element having a bottom locking member and a top locking member. The top locking member may be pivotally coupled to the bottom locking member. The bottom locking member may include a cylindrical extension configured to detachably couple with the vertical extension. More particularly, the vertical extension may include a blind hole at a top end thereof to receive the cylindrical extension of the bottom locking member. The top locking member and the bottom locking member may include grooves as explained with reference to the pivot member 226 and the vertical projection 228. As such, the locking element may be rotated 360 degrees about a central axis of the cylindrical extension of the bottom locking member. The vertical extension may further include a threaded hole to receive a bolt. The bolt may be used to retain the locking element at a desired position. Due to the pivotal coupling of the vertical extension and the locking element, orientation of the grooves in the locking element may be changed and the locking bar 220 may be attached with a frame of the stroller 100.

The extendable arm 216 includes a first bracket member 238 configured to couple with the locking bars 220 and the second member 204 of the extendable leg 200. The first bracket member 238 defines a pair of through holes 240 and a first through hole 242. A first pin 244 is used to couple the first bracket member 238 with the locking bar 220 at the first end 222, when the through hole 240 of the first bracket member 238 is aligned with one of a first through hole 246 of the locking bar 220. A second pin 248 is used to couple the first bracket member 238 with the locking bar 220 at the second end 224, when the through hole 240 of the first bracket member 238 is aligned with one of a second multiple through holes 250 of the locking bar 220. The first pin 244 and the second pin 248 may be disengaged for allowing telescopic movement of the locking bars 220 with respect to the first bracket member 228 along the third axis B-B′. In such a manner, the locking bar 220 may be moved relative to the second member 204 along the second axis B-B′. A fastening pin 252 is used to couple the first bracket member 238 with the second member 204 of the extendable leg 200, when the first through hole 242 of the first bracket member 238 is aligned with a through hole 254 of the second member 204. Thus, the extendable arm 216 is detachably coupled to the second member 204 of the extendable leg 200. Thereby, when the stroller rack 102 is not deployed, the extendable arm 216 may be disassembled from the second member 204 of the extendable leg 200 and stored in the vehicle 106 without consuming excessive space therein.

In another embodiment, another through hole, identical to the first through hole 242, may be provided in the first bracket member 238 perpendicular to the first through hole 242. In such case, the extendable arm 216 may be rotated 90 degrees clockwise and the through hole of the first bracket member 238 may be aligned with the through hole 254 of the second member 204. Further, the fastening pin 252 may be used to detachably couple the extendable arm 216 with the second member 204 of the extendable leg 200. The pivot member 226 and the vertical projection 228 may be provided with a ball and socket arrangement to allow 360 degrees rotation thereof. In another example, the pivot member 226 and the vertical projection 228 may be designed identical to the locking element as explained above. Thus, the locking bar 220 may be configured to attach with the frame of the stroller 100.

The stroller rack 102 further includes a base 256 detachably coupled to the first member 202 of the extendable leg 200. In an example, when the stroller rack 102 is not deployed, the base 256 may be disassembled from the first member 202 of the extendable leg 200 and stored in the vehicle 106 without consuming excessive space therein. The base 256 is pivotally coupled to the first member 202 of the extendable leg 200 and may move to a first locking position and a second locking position. The base 256 includes a beam member 257 defining a first through hole 258 and a second through hole 260. Further, the first member 202 of the extendable leg 200 defines a through hole 262. A pin 264 is used to couple the beam member 257 of the base 256 with the first member 202, when the first through hole 258 and the through hole 262 are aligned. The pin 264 is used for coupling the base 256 with the first member 202, thereby retaining the base 256 in a horizontal plane (i.e., in the first locking position as shown in FIG. 2). In an aspect, when the rack 102 is not in use, the second through hole 260 and the through hole 262 are aligned, and the pin 264 is used to couple the base 256 with the first member 202 and hence retain the base 256 in a vertical plane (i.e., the second locking position). The base 256 includes one or more holding members 270 configured to couple with the pair of rear wheels 108 of the stroller 100. In the illustrated embodiment, the holding member 270 has a rectangular cross-section. In other examples, the extendable leg 200 may have a circular cross-section, a square cross section, and a polygon cross section. In the illustrated embodiment, the holding member 270 may be plastic, wooden plank, or other suitable material capable of holding the pair of rear wheels 108. The beam member 257 may be manufactured in such a way that, the beam member 257 is capable of withstanding a weight of the holding member 270 and other items, such as stroller 100, placed on holding member 270. In an alternate embodiment, the holding member 270 may couple with the front wheel 110 of the stroller 100. As an example, such may be the case for a stroller 100 that when collapsed the handle 112 and the rear wheels 108 may be presented on a similar horizontal plane as the locking bar 120. In this manner, the front wheels of stroller 100 is on plane with the holding member 270 (not shown). In yet another embodiment, when two strollers are used, handle of one stroller may be coupled to one locking bar 220 at the first end 222 and handle of another stroller may be coupled to the locking bar 220 at the second end 224. The one or more wheels of the one or more strollers may be supported on the holding member 270. In an alternate embodiment, a sliding arrangement having a pair of slidable planks may be provided on a top surface of the holding member 270. One sliding plank may be capable of being slid in a direction opposite to the other sliding plank, thereby providing an extended support surface to support rear wheels of multiple strollers. In another example, multiple sliding planks may constitute the holding member 270 and may function in a manner similar to that of the above embodiment.

Further, the holding member 270 includes a pair of bands 272 configured to couple with the pair of rear wheels 108 of the stroller 100. In an example, the bands 272 may be a strap-like arrangement to be wrapped around the pair of rear wheels 108 of the stroller 100. Once the pair of rear wheels 108 is rested on the holding member 270, the bands 272 are wrapped around the pair of rear wheels 108 of the stroller 100 to secure the pair of rear wheels 108 to the holding member 270. In an example, the bands 272 may be used to secure the front wheel 110 of the stroller 100 to the holding member 270 of the base 256. In another example, if multiple strollers are used, the bands 272 may be used to secure the one or more wheels of the multiple strollers to the holding member 270. Although, the pair of bands 272 is described in the illustrated embodiment, it may be understood that the holding member 270 may include only one band to couple the pair of wheels 108 with the holding member 270. In an alternate embodiment, a clamping arrangement may be used instead of the bands 272 to couple with the pair of rear wheels 108 of the stroller 100.

The stroller rack 102 further includes a mounting bar 274 configured to couple the first member 202 of the extendable leg 200 with a hitch mount 268 (as shown in FIG. 1) of the vehicle 106. The hitch mount 268 may be a device attached to a chassis of the vehicle 106. Exemplary FIG. 1 illustrates a stroller rack 102 attached at the rear end of a vehicle 106 at the hitch mount 268. It is understood to be within the scope of the present disclosure that a stroller rack 102 may be attached at the front end of vehicle 106 using a front mount receiver hitch such as the model #31198 front mount receiver hitch manufactured by Curt Manufacturing (not shown). The mounting bar 274 includes a first end 278 having a through hole 280 and a second end 282 having a through hole 284. A pin 286 is used to detachably couple the mounting bar 274 with the first member 202, when the through hole 280 of the mounting bar 274 and a through hole 288 defined in the first member 202 are aligned. More particularly, the first member 202 has a cut-out portion 290 to receive a corresponding portion at the first end 278 of the mounting bar 274 therethrough. During assembly, the first end 278 of the mounting bar 274 is received within the cut-out portion 290 and the through hole 280 of the mounting bar 274 and the through hole 288 defined in the first member 202 are aligned. Further, the pin 286 is used to couple the mounting bar 274 to the first member 202. Further, A pin (not shown) is used to couple the second end 282 of the mounting bar 274 with the hitch mount 268 of the vehicle 106, when the through hole 284 defined at the second end 282 of the mounting bar 274 is aligned with a hole (not shown) of the hitch mount 268 of the vehicle 106.

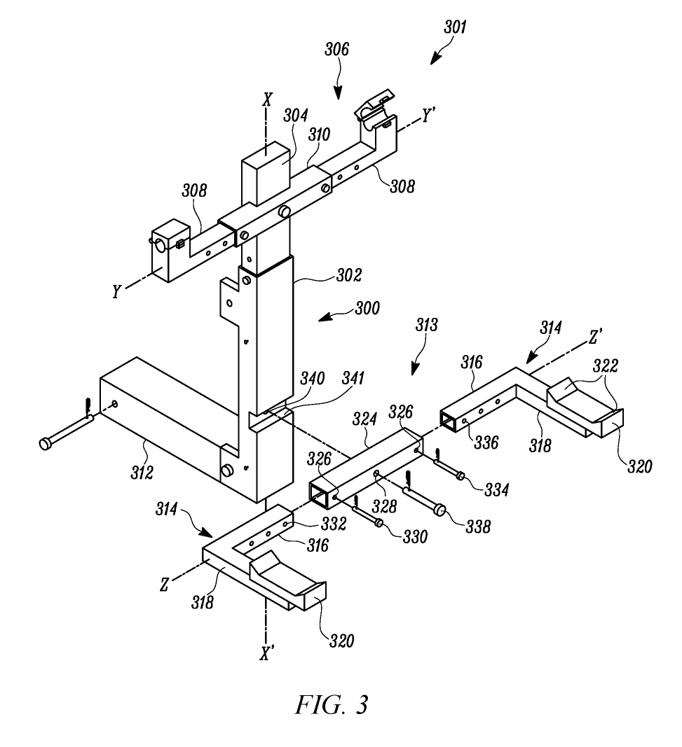

FIG. 3 is a partial exploded view of a stroller rack 301 for coupling with the hitch mount 268 of the vehicle 106, according to another embodiment of the present disclosure. The stroller rack 301 includes an extendable leg 300 including a first member 302 configured to attach with the vehicle 106. The extendable leg 300 further includes a second member 304 configured to move relative to the first member 302 along a first axis X-X′. The stroller rack 301 further incudes an extendable arm 306 detachably coupled to the second member 304 of the extendable leg 300. The extendable arm 306 includes a pair of locking bars 308. The locking bars 308 are configured to move relative to the second member 304 along a second axis Y-Y′. The locking bars 308 are configured to attach with the handle 112 of the stroller 100. A second bracket member 310 is configured to couple with the locking bar 308 and the second member 304 of the extendable leg 300. The stroller rack 301 further includes a mounting bar 312 configured to couple the first member 302 of the extendable leg 300 with the hitch mount 268 (as shown in FIG. 1) of the vehicle 106. The constructional and functional features of the extendable leg 300, the first member 302, the second member 304, the extendable arm 306, the locking bars 308, the second bracket member 310, and the mounting bar 312 are the same as explained with respect to the extendable leg 200, the first member 202, the second member 204, the extendable arm 216, the locking bars 220, the first bracket member 238, and the mounting bar 274 of FIG. 2.

The stroller rack 301 further includes a base 313 having one or more holding members 314 configured to move relative to the first member 302 along a third axis Z-Z′ that is parallel to the second axis Y-Y′. In the illustrated embodiment, the base 313 includes a pair of holding members 314. Each of the holding members 314 includes a base bar 316 and an extension 318. The extension 318 protrudes in a direction perpendicular to the base bar 316. In an example, the extension 318 may be configured to accommodate and secure one or more rear wheels 108 of the stroller 100. The holding members 314 further include one or more coupling members 320 configured to couple with the pair of rear wheels 108 of the stroller 100. In the illustrated embodiment, one coupling member 320 is provided on each extension 318 of the holding member 314. In an example, the coupling member 320 may be welded to the extension 318 of the holding member 314. In another example, the coupling member 320 may have a sliding movement along a length of the extension 318 to receive the pair of rear wheels 108 of the stroller 100. The coupling member 320 may be capable of accommodating and securing the one or more rear wheels 108. In another example, the coupling member 320 may include ramp like structures, indicated by reference numeral 322, on either ends thereof. During travel of the vehicle 106, the rear wheel 108 rested on the coupling member 320 may tend to slip out of the coupling member 320 due to vibrations developed in the vehicle 106. The ramp like structures may firmly hold the rear wheel 108 and thereby prevent the rear wheel 108 from slipping. In an alternate embodiment, the holding members 314 may include adjustable coupling members to accommodate and secure the pair of rear wheels 108. More particularly, one end of the coupling member may be provided a ramp like structures, and other end of the coupling member may be provided with a spring actuated retainer to push and secure the pair of rear wheels 108 against the ramp like structure. In a further alternate embodiment, the coupling member 320 may be configured as a hollowed torus-shaped structure allowing wheels 108 to rest therebetween its radiused sidewalls (not shown).

Although, in the illustrated embodiment, the extension 318 is integral to the base bar 316, it may be understood that the extension 318 may be made as an individual component and detachably coupled to the base bar 316 to make the extension 318 capable of being locked at desired positions in a horizontal plane with respect to the base bar 316. With such an arrangement of the holding member 314, strollers having various wheel bases and multiple wheels may be accommodated on the stroller rack 301.

The base 313 further includes a third bracket member 324 configured to couple with the holding members 314 and the first member 302 of the extendable leg 300. The third bracket member 324 defines a pair of through holes 326 and a first through hole 328. A first pin 330 is used to couple the third bracket member 324 with one holding member 314, when the through hole 326 of the third bracket member 324 is aligned with one through hole of a first multiple through holes 332 of the holding member 314. A second pin 334 is used to couple the third bracket member 324 with another holding member 314, when the through hole 326 of the third bracket member 324 is aligned with one through hole of a second multiple through holes 336 of the holding member 314. The first pin 330 and the second pin 334 may be disengaged for allowing telescopic movement of the holding bars 314 with respect to the third bracket member 324 along the third axis Z-Z″. In such a manner, the holding bars 314 may be moved relative to the first member 302 along the third axis Z-Z′. A fastening pin 338 is used to detachably couple the third bracket member 324 with the first member 302 of the extendable leg 300, when the first through hole 328 of the third bracket member 324 is aligned with a through hole 340 of the first member 302. More particularly, a groove 341 is defined in the first member 302 to receive the third bracket member 324, and hence to provide structural rigidity to the coupling of the base 313 with the first member 302. Although the illustrated embodiment of FIG. 3 depicts rectangular-shaped elements (e.g., bracket member 310, base 313, etc.) it is understood that such elements may cooperate as described being constructed of different shapes (e.g., tubular).

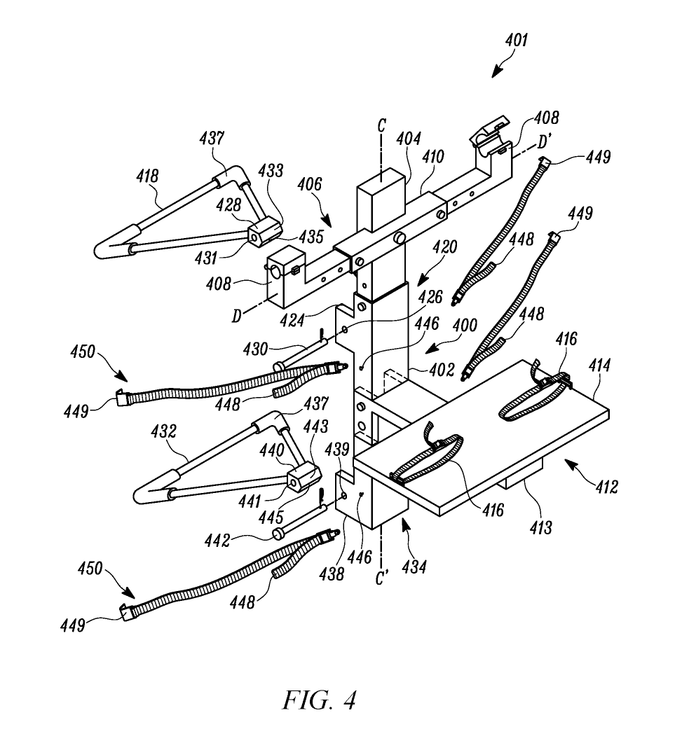

FIG. 4 is a partial exploded view of a stroller rack 401 for attaching with a trunk portion or a hatchback portion 403 (as shown in FIG. 1) of the vehicle 106, according to yet another embodiment of the present disclosure. The stroller rack 401 includes an extendable leg 400 including a first member 402 configured to attach with the vehicle 106 and a second member 404 configured to move relative to the first member 402 along a first axis C-C′. The stroller rack 401 further incudes an extendable arm 406 detachably coupled to the second member 404 of the extendable leg 400. The extendable arm 406 includes a pair of locking bars 408. Each locking bar 408 is configured to move relative to the second member 404 along a second axis D-D′ that is perpendicular to the first axis C-C′. Further, each locking bar 408 is configured to attach with the handle 112 of the stroller 100. In an alternate embodiment, the extendable arm 406 may include one locking bar 408 configured to attach with the handle 112 and move relative to the second member 404 of the extendable leg 400. The extendable arm 406 further includes a fourth bracket member 410 configured to couple with the locking bars 408 and the second member 404 of the extendable leg 400. The stroller rack 401 further includes a base 412 detachably and pivotally coupled to the first member 402 of the extendable leg 400. The base 412 includes a beam member 413 and a holding member 414 supported on the beam member 413. The holding member 414 is configured to couple with the pair of rear wheels 108 of the stroller 100. Further, the holding member 414 includes multiple bands 416 configured to couple with the pair of rear wheels 108 of the stroller 100. The constructional and functional features of the extendable leg 400, the first member 402, the second member 404, the extendable arm 406, the locking bars 408, the fourth bracket member 410, the base 412, the holding member 414 and the bands 416 are same as explained with respect to the extendable leg 200, the first member 202, the second member 204, the extendable arm 216, the locking bars 220, the first bracket member 238, the base 256, the holding member 270 and the bands 272 of FIG. 2.

Mounting of the stroller rack 401 is illustrated in detail with reference to the vehicle 106 shown in FIG. 1. The stroller rack 401 further includes a first supporting member 418 pivotally coupled to a top end 420 of the first member 402 of the extendable leg 400. The first supporting member 418 is further configured to rest on a top body portion 422 (as shown in FIG. 1) of the rear end 104 of the vehicle 106. In the illustrated embodiment, the first supporting member 418 is a triangle shaped member coupled to the top end 420 of the first member 402 to rest on the top body portion 422 of the vehicle 106. In an example, the first supporting member 418 can be of any shape, such as a square shape, a rectangular shape, a polygon shape, a T-shape, or any other shape having an elongated base to support or rest on the top body portion 422 of the vehicle 106. In the illustrated embodiment, the first member 402 includes a first extension 424 protruding radially outward. The first extension 424 has a first through hole 426 to couple with the first supporting member 418. The first supporting member 418 includes a first flange member 428 configured to couple with the first extension 424. The first flange member 428 is coupled to the first extension 424 of the first member 402 through a pin 430, when the first through hole 426 is aligned with a through hole 431 of the first flange member 428. The first flange member 428 further includes a top surface 433 and a bottom surface 435. The top surface 433 positions the first supporting member 418 in a direction inclined upward and the bottom surface 435 positions the first supporting member 418 in a direction inclined downward with respect to the extendable leg 400. In an example, when the stroller rack 401 is to be mounted to a sedan type vehicle, the first supporting member 418 may be inclined downward, and when the stroller rack 401 is to be mounted to a hatchback vehicle and a sports utility vehicle (SUV), the first supporting member 418 may be inclined upward. In the illustrated embodiment, the first supporting member 418 includes a bush member 437 for preventing scratches on the top body portion 422 of the vehicle 106.

The stroller rack 401 further includes a second supporting member 432 pivotally coupled to a bottom end 434 of the first member 402 of the extendable leg 400. The second supporting member 432 is configured to rest on a bottom body portion 436 (as shown in FIG. 1) of the rear end 104 of the vehicle 106. In the illustrated embodiment, the second supporting member 432 is a triangle shaped member coupled to the bottom end 434 of the first member 402 to rest on the bottom body portion 436 of the vehicle 106. In an example, the second supporting member 432 can be of any shape, such as a square shape, a rectangular shape, a polygon shape, a T-shape, or any other shape having an elongated base to support or rest on the bottom body portion 436 of the vehicle 106. In the illustrated embodiment, the first member 402 includes a second extension 438 protruding radially outward. The second extension 438 has a second through hole 439 to couple with the second supporting member 432. The second supporting member 432 includes a second flange member 440 configured to couple with the second extension 438. The second flange member 440 is coupled to the second extension 438 of the first member 402 through a pin 442, when the second through hole 439 is aligned with a through hole 441 of the second flange member 440. The second flange member 440 further includes a top surface 443 and a bottom surface 445. The top surface 443 positions the second supporting member 432 in a direction inclined upward and the bottom surface 445 positions the second supporting member 432 in a direction inclined downward with respect to the extendable leg 400. In an example, when the stroller rack 401 is to be mounted to a sedan type vehicle, the second supporting member 432 may be inclined downward, and when the stroller rack 401 is to be mounted to a hatchback vehicle and a sports utility vehicle (SUV), the second supporting member 432 may be inclined upward. In the illustrated embodiment, the second supporting member 418 includes the bush member 437 for preventing scratches on the bottom body portion 436 of the vehicle 106.

The stroller rack 401 further includes a plurality of straps 444 attached to the first member 402 of the extendable leg 400. In the illustrated embodiment, the first member 402 includes multiple hook members 446 configured to couple with a second end 448 of each of the plurality of straps 444. A first end 450 of each of the plurality of straps 444 is configured to be coupled with the trunk portion or the hatchback portion 403 of the vehicle 106. In the illustrated embodiment, each of the plurality of straps 444 has a clamp 449 at the first end 450 to couple with an edge of a trunk door or a rear door of the vehicle 106. The second end 448 of each of the plurality of straps 444 is configured to couple with the multiple hook members 446 such that a length of each of the plurality of straps 444 may be adjusted to securely attach the stroller rack 401 with the trunk portion or the hatch back portion 403 of the vehicle 106. The first supporting member 418, the second supporting member 432, and the plurality of straps 444 are together configured to mount the stroller rack 401 at the rear end 104 of the vehicle 106.

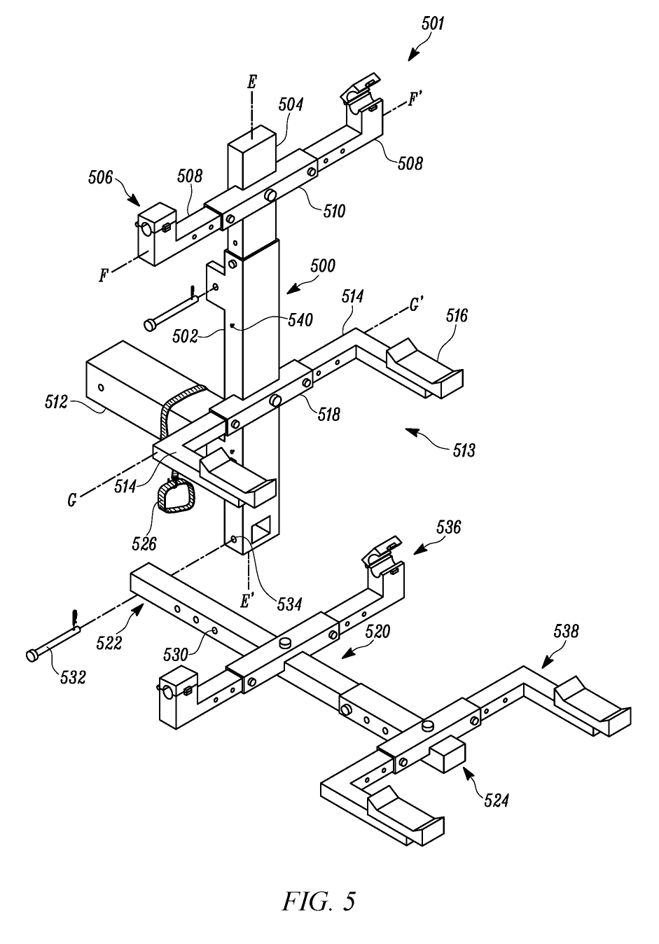

FIG. 5 is a perspective view of a stroller rack 501 for attaching with the rear end 104 of the vehicle 106, according to yet another embodiment of the present disclosure. The stroller rack 501 includes an extendable leg 500 having a first member 502 configured to attach with the vehicle 106. The extendable leg 500 further includes a second member 504 configured to move relative to the first member 502 along a first axis E-E′. The stroller rack 501 further incudes a first extendable arm 506 detachably coupled to the second member 504 of the extendable leg 500. The first extendable arm 506 includes a pair of locking bars 508. Each of the pair of locking bar 508 is configured to move relative to the second member 504 along a second axis F-F′. Further, the locking bars 508 are configured to attach with the handle 112 of the stroller 100. A fifth bracket member 510 is configured to couple with the locking bars 508 and the second member 504 of the extendable leg 500. The stroller rack 501 further includes a mounting bar 512 configured to couple the first member 502 of the extendable leg 500 with the hitch mount 268 (as shown in FIG. 1) of the vehicle 106. The stroller rack 501 further includes a base 513 having a first set of holding members 514 configured to move relative to the first member 502 along a third axis G-G′ that is parallel to the second axis F-F′. Each of the holding members 514 includes one or more coupling members 516 configured to couple with at least one of the pair of rear wheels 108 of the stroller 100 of FIG. 1. The base 513 includes a sixth bracket member 518 configured to couple with the holding members 514 and the first member 502 of the extendable leg 500. The constructional and functional features of the extendable leg 500, the first member 502, the second member 504, the first extendable arm 506, the locking bars 508, the fifth bracket member 510, the mounting bar 512, the holding members 514, the coupling members 516, and the sixth bracket member 518 are the same as explained with respect to the extendable leg 300, the first member 302, the second member 304, the extendable arm 306, the locking bars 308, the second bracket member 310, the mounting bar 312, the holding members 314, the coupling members 320, and the third bracket member 324 of the FIG. 3.

The stroller rack 501 includes a leg member 520 having a first end 522 and a second end 524. The first end 522 is coupled to the mounting bar 512 via a strap 526. The leg member 520 is located underneath the rear end 104 of the vehicle 106. The leg member 520 of the stroller rack 501 is configured to couple with the first member 502 and defines multiple holes 530. A pin 532 is used to couple the leg member 520 with the first member 502, when one of the multiple holes 530 is aligned with a hole 534 of the first member 502. A second extendable arm 536 and a base 538 are detachably coupled to the leg member 520 of the stroller rack 501. The constructional and functional features of the second extendable arm 536 are similar to that of the extendable arm 216 of FIG. 2. Similarly, the constructional and functional features of the base 538 are similar to that of the base 313 of FIG. 3. In the illustrated embodiment, the first extendable arm 506 and the base 513 are configured to secure and accommodate one stroller and the second extendable arm 536 and the base 538 are configured to secure and accommodate another stroller. In an example, when the stroller rack 501 is to be mounted to the trunk portion of a sedan type vehicle, a hatchback vehicle, and a sports utility vehicle (SUV), the mounting bar 512 may be disassembled and replaced with the second supporting member 432 of FIG. 4. Further, the first supporting member 418 of FIG. 4 may be pivotally coupled to a first extension of the first member 502 for supporting on the trunk portion of the vehicle 106. In addition, a plurality of straps (not shown) may be attached to the first member 502 of the extendable leg 500. The first member 502 may include multiple hook members 540 to couple with the plurality of straps.

### INDUSTRIAL APPLICABILITY

The present disclosure relates to the stroller racks 102, 301, 401, and 501 mounted at the rear end 104 of the vehicle 106. The stroller racks 102, 301, 401 and 501 assists in mounting of the stroller 100 to the rear end 104 of the vehicle 106. The stroller rack 102 of the present disclosure facilitates locking of the handle 112 of the stroller 100 to the stroller rack 102. By locking the handle 112 of the stroller 100, stealing of the stroller 100 from back off the vehicle 106 is prevented. Also, the locking bars 220, 308, 408, and 508 are capable of accommodating handle bars of any length. In particular, the locking bars 220, 308, 408, and 508 secure the handle 112 within the cavity (as shown in FIG. 2). In addition, bases 256, 313, 412 and 513 are provided for resting of the rear wheels 108 of the stroller 100. The bases 256, 313, 412 and 513, the extendable legs 200, 300, 400 and 500, and the extendable arms 216, 306, 406 and 506 can be disassembled from the stroller racks 102, 301, 401 and 501 when the stroller racks 102, 301, 401 and 501 are not in use, thereby reducing the space consumed by the stroller racks 102, 301, 401 and 501 when not deployed. Further, the stroller racks 102, 301, 401 and 501 of the present disclosure can be coupled with any type of stroller present in the market. Also, coupling and decoupling of the stroller racks 102, 301, 401 and 501 with the stroller 100 is made easy compared to the existing methods as the components such as the bases 256, 313, 412 and 513, the extendable legs 200, 300, 400 and 500, and the extendable arms 216, 306, 406 and 506 are coupled and decoupled using multiple pins. In an example, when the vehicle 106 is without the hitch mount 268, the stroller rack 401 may be coupled with the vehicle 106 using the first supporting member 418, the second supporting member 432, and the plurality of straps 444.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A stroller rack for a vehicle, the stroller rack comprising:
an extendable leg comprising a first member configured to attach with the vehicle and a second member configured to move relative to the first member along a first axis;
an extendable arm detachably coupled to the second member of the extendable leg and comprising one or more locking bars configured to attach with a handle of one or more strollers, the one or more locking bars are configured to move relative to the second member along a second axis, wherein the second axis is perpendicular to the first axis; and
a base detachably coupled to the first member of the extendable leg and comprising one or more holding members configured to couple with one or more wheels of the one or more strollers.

2. The stroller rack of claim 1, wherein the base is pivotally coupled to the first member of the extendable leg and is configured to move to a first locking position and a second locking position, wherein
in the first locking position, the base is positioned in a horizontal plane, and
in the second locking position, the base is positioned in a vertical plane.

3. The stroller rack of claim 1, wherein the one or more holding members comprise one or more bands configured to couple with the one or more wheels of the one or more strollers.

4. The stroller rack of claim 1, wherein the one or more holding members include one or more coupling members configured to couple with the one or more wheels of the one or more strollers.

5. The stroller rack of claim 1, wherein the one or more holding members are configured to move relative to the first member along a third axis, wherein the third axis is parallel to the second axis.

6. The stroller rack of claim 1, wherein the base further includes a third bracket member configured to couple with the one or more holding members and the first member of the extendable leg, wherein the one or more holding members are configured to telescopically move relative to the third bracket member along a third axis, wherein the third axis is parallel to the second axis.

7. The stroller rack of claim 1, wherein each locking bar includes a pivot member configured to move between an open position and a closed position, wherein the pivot member secures the handle of the one or more strollers in the closed position.

8. The stroller rack of claim 1, wherein the extendable arm further includes a first bracket member configured to couple with the second member of the extendable leg and the one or more locking bars, wherein the one or more locking bars are configured to telescopically move relative to the first bracket member along the second axis.

9. The stroller rack of claim 1 further comprising a mounting bar configured to couple the first member of the extendable leg with a hitch mount of the vehicle.

10. The stroller rack of claim 1 further comprising:
a first supporting member pivotally coupled to a top end of the first member of the extendable leg, and is configured to rest on a top body portion of an end of the vehicle;
a second supporting member pivotally coupled to a bottom end of the first member of the extendable leg and is configured to rest on a bottom body portion of the end of the vehicle; and
a plurality of straps attached to the first member of the extendable leg, wherein the first supporting member, the second supporting member and the plurality of straps are configured to mount the stroller rack at the end of the vehicle.

11. A vehicle, comprising:
a stroller rack mounted at an end of the vehicle for supporting one or more strollers, the stroller rack including:
an extendable leg comprising a first member coupled to the end of the vehicle and a second member configured to move relative to the first member along a first axis;
an extendable arm detachably coupled to the second member of the extendable leg and comprising one or more locking bars configured to attach with a handle of one or more strollers, the one or more locking bars are configured to move relative to the second member along a second axis, wherein the second axis is perpendicular to the first axis; and
a base detachably coupled to the first member of the extendable leg and comprising one or more holding members configured to couple with one or more wheels of the one or more strollers.

12. The vehicle of claim 11, wherein the base is pivotally coupled to the first member of the extendable leg and is configured to move to a first locking position and a second locking position, wherein
in the first locking position, the base is positioned in a horizontal plane, and
in the second locking position, the base is positioned in a vertical plane.

13. The vehicle of claim 11, wherein the one or more holding members comprise one or more bands configured to couple with the one or more wheels of the one or more strollers.

14. The vehicle of claim 11, wherein the one or more holding members include one or more coupling members configured to couple with the one or more wheels of the one or more strollers.

15. The vehicle of claim 11, wherein the one or more holding members are configured to move relative to the first member along a third axis, wherein the third axis is parallel to the second axis.

17. The vehicle of claim 11, wherein each locking bar includes a pivot member configured to move between an open position and a closed position, wherein the pivot member secures the handle of the one or more strollers in the closed position.

18. The vehicle of claim 11 further comprising a hitch mount coupled to the end of the vehicle, and a mounting bar of the stroller rack couples the first member of the extendable leg with the hitch mount.

19. The vehicle of claim 11, wherein the stroller rack further includes:
a first supporting member pivotally coupled to a top end of the first member of the extendable leg and is configured to rest on a top body portion of an end of the vehicle;
a second supporting member pivotally coupled to a bottom end of the first member of the extendable leg and is configured to rest on a bottom body portion of the end of the vehicle; and
a plurality of straps attached to the first member of the extendable leg, wherein the first supporting member, the second supporting member and the plurality of straps are configured to mount the stroller rack at the end of the vehicle.

20. A stroller rack for a vehicle, the stroller rack comprising:
an extendable leg comprising a first member configured to attach with the vehicle and a second member configured to move relative to the first member along a first axis;
an extendable arm including:
a first bracket member detachably coupled to the second member of the extendable leg; and
one or more locking bars configured to couple with the first bracket member and telescopically move relative to the first bracket member along a second axis, wherein the second axis is perpendicular to the first axis, each locking bar includes a pivot member configured to move between an open position and a closed position, wherein the pivot member secures a handle of one or more strollers; and
a base detachably coupled to the first member of the extendable leg and comprising one or more holding members configured to couple with one or more wheels of the one or more strollers.
